(19) United States
(12) Patent Application Publication
(10) Pub. No.: US 2023/0241689 A1
(43) Pub. Date: Aug. 3, 2023

(54) SPLIT FRAME DEVICE FOR PERFORMING OPERATIONS ON CYLINDRICAL ITEMS

(71) Applicant: Team Industrial Services, Inc., Sugar Land, TX (US)

(72) Inventors: Mark KING, Cumbria (GB); Jimi WADE, Cumbria (GB)

(21) Appl. No.: 18/021,996

(22) PCT Filed: Aug. 18, 2021
(86) PCT No.: PCT/US2021/046509

§ 371 Date: Feb. 17, 2023

Related U.S. Application Data
(60) Provisional application No. 63/074,299, filed on Sep. 3, 2020.

(51) Int. Cl. B23B 5/08; B23Q 9/00

(52) U.S. Cl. CPC B23B 5/08; B23Q 9/0021; B23B 2270/22; B23B 2260/03

(57) ABSTRACT

A technique facilitates performance of an operation on a cylindrical item, such as a tube or shaft. The technique utilizes a split frame device having separable sections to enable mounting of the split frame device about the cylindrical item while, for example, the cylindrical item remains in place in an overall system. The split frame device may comprise first and second non-rotating split frame steady assemblies supported by linear rails. A rotating tool carrier assembly is movably mounted on the linear rails between the first and second non-rotating split frame steady assemblies. The rotating tool carrier assembly may be positioned about the cylindrical item such that a rotatable component may be rotated about the cylindrical item. At least one power source may be used to impart axial movement to the rotating tool carrier assembly and/or rotational movement to the rotatable component for performance of a desired operation.

### CROSS-REFERENCE TO RELATED APPLICATION

The present document is based on and claims priority to U.S. Provisional Application Ser. No.: 63/074299, filed Sep. 3, 2020, which is incorporated herein by reference in its entirety.

### FIELD OF DISCLOSURE

In general, the disclosure describes a journal turning lathe system having a split frame configuration which is readily located onto existing or new equipment on-site.

### BACKGROUND OF DISCLOSURE

Many types of industrial applications utilize various cylindrical items, such as pipes or shafts, as components in an overall industrial system. If a cylindrical item requires refurbishing or other types of repair, the cylindrical item may be disassembled and removed from the overall industrial system to enable transport to a workshop location for the repair. By way of example, the cylindrical item may be transported to a workshop and mounted on a lathe to enable machining, e.g. resurfacing, of certain portions of the pipe, shaft, or other cylindrical item. However, removal of many types of cylindrical items can be time-consuming and expensive. Additionally, the removal can sometimes result in shutting down operation of the overall industrial system during the repair.

What is needed is a portable journal turning lathe which can be taken on-site and mounted to a given cylindrical item for performance of the desired repair or other operation without disassembly and removal of the cylindrical item.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

An embodiment of the present disclosure provides a system and methodology for performing an operation on a cylindrical item, such as a tube or shaft. The technique utilizes a split frame device having separable sections to enable mounting of the split frame device about the cylindrical item while, for example, the cylindrical item remains in place in an overall system. According to an embodiment, the split frame device comprises a plurality of, e.g. first and second, non-rotating split frame steady assemblies supported by linear rails. A rotating tool carrier assembly may be movably mounted on the linear rails between the first and second non-rotating split frame steady assemblies. The rotating tool carrier assembly comprises a rotatable component while also being movable axially along the linear rails. The rotating tool carrier assembly is constructed with separable sections to enable positioning about the cylindrical item such that the rotatable component may be rotated about the cylindrical item. At least one power source may be used to impart axial movement to the rotating tool carrier assembly and/or rotational movement to the rotatable component for performance of a desired operation.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is an orthogonal view of an example of a split frame device mounted about a cylindrical item, in accordance with embodiments of the present disclosure;

FIG. 2 is another orthogonal view of the split frame device illustrated in FIG. 1 but from a different angle and in a different operational position, in accordance with embodiments of the present disclosure;

FIG. 3 is a side view of the split frame device illustrated in FIG. 2, in accordance with embodiments of the present disclosure;

FIG. 4 is an end of view of the split frame device illustrated in FIG. 2, in accordance with embodiments of the present disclosure; and

FIG. 5 is a cross-sectional view of the split frame device, in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

According to an embodiment, a system and methodology are provided for facilitating performance of a desired operation or operations on a cylindrical item, such as a tube or shaft. The technique utilizes a split frame device having separable sections to enable mounting of the split frame device about the cylindrical item while, for example, the cylindrical item remains in place in an overall system. For example, the split frame device may be split and located onto existing or new site equipment without disassembling the site equipment. The split frame device is readily transportable to the site equipment so that it may be appropriately mounted on the site equipment for performance of, for example, desired machining tasks, e.g. machining of bearing surfaces, on the cylindrical items. The split frame device may be constructed as a modular device which may be configured in various lengths for mounting about tubes, shafts, or other cylindrical items with varying diameters so as to suit a given site application.

According to an embodiment, the split frame device comprises a plurality of, e.g. first and second, non-rotating split frame steady assemblies supported by linear rails. A rotating tool carrier assembly may be movably mounted on the linear rails between the first and second non-rotating split frame steady assemblies. The rotating tool carrier assembly comprises a rotatable component while also being movable axially along the linear rails. The rotating tool carrier assembly is constructed with separable sections to enable positioning about the cylindrical item such that the rotatable component may be rotated about the cylindrical item. The rotating tool carrier assembly may be used to locate and move desired tools with respect to the cylindrical item. In some embodiments, the rotating tool carrier assembly may be used to locate a cutting tool and/or a striker assembly in radial and/or axial directions.

At least one power source may be used to impart axial movement to the rotating tool carrier assembly and rotational movement to the rotatable component for performance of a desired operation. By way of example, the at least one power source may comprise a single motor or combinations of motors. Examples of suitable motor configurations include pneumatic motors, hydraulic motors, and electric motors.

According to an embodiment, the split frame device may be constructed in the form of a lightweight, portable journal turning lathe. The split frame configuration of the lightweight and portable journal turning lathe facilitates machining of a variety of cylindrical items while the cylindrical items remain in place in an overall industrial system or other system. The split frame journal turning lathe may be located around the cylindrical item and then operated to perform the desired machining work or another type of desired work on the cylindrical item. This approach removes the need to disassemble and remove the cylindrical item from its site location so that it can be worked on at a remote workshop location. The split frame design enables simple and easy assembly around a desired cylindrical item on-site. The non-rotating steady assemblies and striker assemblies reduce operator interaction and thus reduce potential hazards of interacting with rotating equipment.

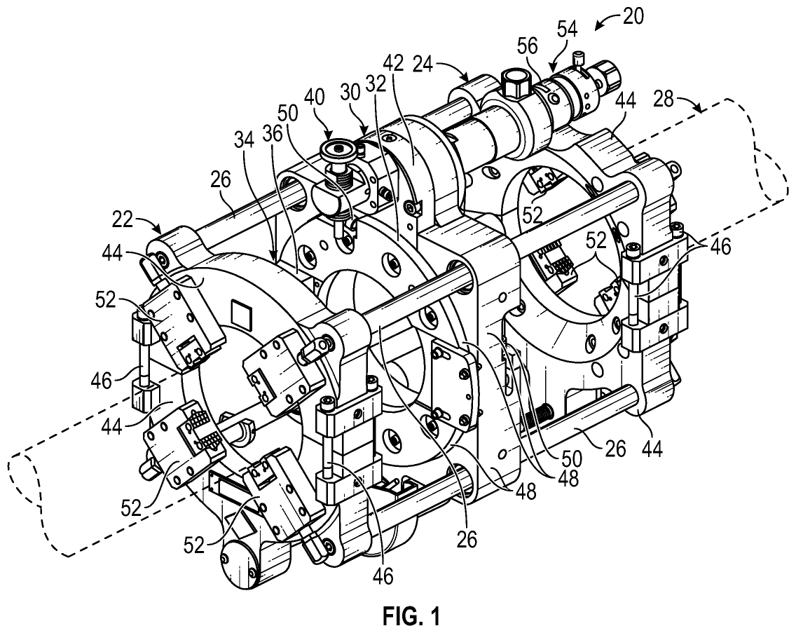

Referring generally to FIGS. 1-3, an example of a split frame device 20 is illustrated in the form of a journal turning lathe. The split frame device/journal turning lathe 20 comprises a plurality of non-rotating split frame steady assemblies. In the specific example illustrated, the plurality of non-rotating split frame steady assemblies comprises first and second non-rotating split frame steady assemblies 22, 24, respectively, although other numbers may be employed. The non-rotating split frame steady assemblies 22, 24 are mounted on a plurality of linear rails 26 and supported at separate locations along the rails 26. As illustrated, the steady assemblies 22, 24 may be positioned at different locations along the rails 26 and/or rails 26 may be constructed with different lengths to provide the split frame device 20 with desired modularity. In other words, the assemblies 22, 24 may be mounted at different locations along a cylindrical item 28, e.g. a tubular member or a shaft, as illustrated in FIG. 1.

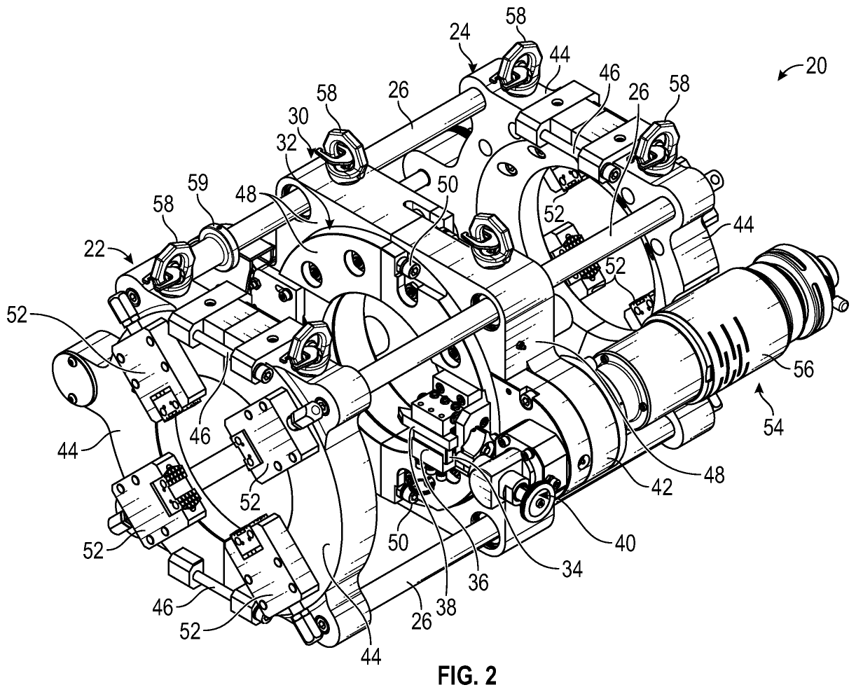

According to the illustrated embodiment, the split frame device 20 also comprises a rotating tool carrier assembly 30 which is movably mounted on the plurality of linear rails 26 to enable axial movement of the assembly 30. The rotating tool carrier assembly 30 is mounted along rails 26 between the first and second non-rotating split frame steady assemblies 22, 24. Additionally, the rotating tool carrier assembly 30 comprises a rotatable component 32 which may be positioned about the cylindrical item 28 for rotation thereabout. As a result, a variety of tool assemblies 34 may be mounted on the rotatable component 32 for rotation about the cylindrical item 28 when performing a desired cutting operation or other operation on the cylindrical item 28. In the specific example illustrated, the tool assembly 34 comprises a tool post assembly 36 constructed for holding a desired tool 38, e.g. a single cutter or other appropriate tool (see FIG. 2). In some embodiments, a striker assembly 40 may be mounted to a nonrotating portion 42 of the rotating tool carrier assembly 30. By way of example, the striker assembly 40 may be used to provide a desired radial feed/position of the tool 38.

It should be noted the split frame device 20 may be split to enable in-place mounting of the device 20 around cylindrical item 28. By way of example, each of the first and second non-rotating split frame steady assemblies 22, 24 may be constructed from separable sections 44, e.g. two separable sections 44, which may be selectively separated and then combined about the cylindrical item 28 via suitable fasteners 46, e.g. bolts. Similarly, the rotating tool carrier assembly 30 may be constructed from separable sections 48, e.g. two separable sections 48, which may be selectively separated and then combined about the cylindrical item 28 via suitable fasteners 50, e.g. bolts. Depending on the construction of each of the non-rotating split frame steady assemblies 22, 24 and rotating tool carrier assembly 30, the separable sections 44, 48 may comprise a plurality of separable sections. For example, the separable sections 48 of rotating tool carrier assembly 30 may comprise separable rotating components and separable nonrotating components which may each be selectively separated for positioning about the cylindrical item 28 and then recombined and fastened together via the appropriate fasteners 50, as illustrated in FIG. 2.

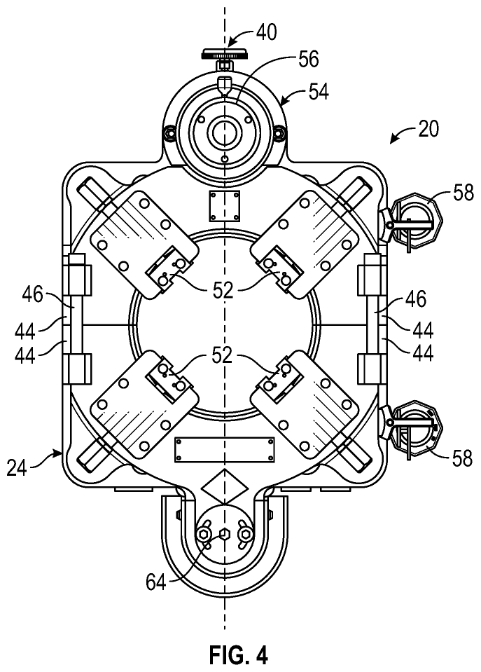

In the example illustrated, each non-rotating split frame steady assembly 22, 24 also comprises a plurality of adjustable clamp assemblies 52. The adjustable clamp assemblies 52 may be mounted to the separable sections 44 and oriented for gripping the cylindrical item 28. Each adjustable clamp assembly 52 may be adjustably mounted on the separable sections 44 to enable adjustment in a radial direction for gripping engagement against cylindrical items 28 of differing diameters (see also FIG. 4). The adjustability of the clamp assemblies 52 in the radial direction provides the split frame device 20 with additional modularity so that it may be used on a wide variety of cylindrical items 28.

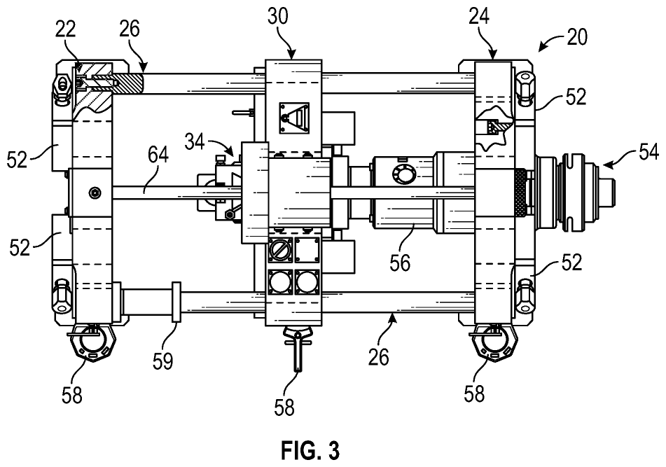

The split frame device 20 may further comprise at least one power source 54 which may be operated to impart rotational motion to the rotatable component 32 and, in at least some cases, axial movement of the rotating tool carrier assembly 30 along the linear rails 26. In the embodiment illustrated, a single power source 54 is mounted to the non-rotating portion 42 of rotating tool carrier assembly 30 and operably connected with the rotatable component 32. The power source(s) 54 may comprise a motor 56. The motor 56 may be selected from a variety of motors, such as pneumatic motors, hydraulic motors, electric motors, or other suitable motors. Depending on the desired applications, the split frame device 20 may have a variety of other components and features, such as lifting hooks 58 arranged to facilitate lifting and movement of the entire split frame device 20 or portions of the split frame device 20. Additional examples include a stop or stops 59 positioned on one or more linear rails 26 to limit axial travel (see FIGS. 2 and 3).

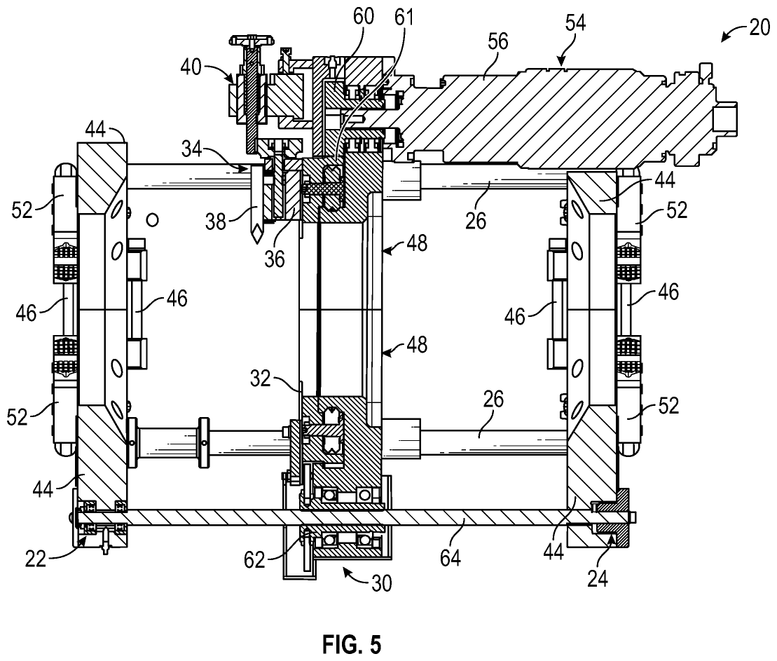

Referring generally to FIG. 5, a cross-sectional illustration is provided to show one example of a coupling technique between the motor 56 and the rotating tool carrier assembly 30. In this example, the motor 56 is connected to a drive gear 60 which, in turn, is operatively coupled with a corresponding portion 61, e.g. a gear portion, of rotatable component 32. As the drive gear 60 is rotated by motor 56, the rotatable component 32 and attached tool 38 are rotated via corresponding gear portion 61. This enables rotation of the tool 38 about the outer surface of the cylindrical item 28. The radial position of tool 38 may be adjusted for the desired interaction with cylindrical item 28 as the rotatable component 32 and tool 38 are rotated about the cylindrical item 28. Radial adjustment of the tool 38 may be provided by striker assembly 40 or other suitable adjustment mechanisms, e.g. an adjustable screw drive or hydraulic actuator.

In some embodiments, the motor 56, or other power source 54, also may be used to move the rotating tool carrier assembly 30 in an axial direction along the linear rails 26. By way of example, rotating component 32 (or other suitable connection with motor 56) may be used to rotate a threaded gear 62 around a corresponding feed screw 64. The feed screw 64 may be connected between the non-rotating split frame steady assemblies 22, 24 or otherwise suitably mounted. The threaded gear 62 is rotatably mounted in the nonrotating portion 42 of rotating tool carrier assembly 30 such that rotation of gear 62 about the corresponding feed screw 64 drives the tool carrier assembly 30 in an axial direction along the linear rails 26. The rotating tool carrier assembly 30 may be slidably mounted on rails 26 via sliding bushings or other components selected to facilitate the linear, sliding motion of assembly 30 during rotation of gear 62 relative to feed screw 64. The direction of axial progression along feed screw 64 depends on the direction of rotation of threaded gear 62.

It should be noted that split frame device 20 may be constructed in a variety of sizes and configurations while maintaining its ability to be split so that it can then mounted about the cylindrical item 28 without disassembling item 28 from the overall system. Additionally, the split frame device 20 may be used with many types of pipes, shafts, or other cylindrical items utilized in a variety of industrial systems or other systems. Examples of industrial systems utilizing many types of cylindrical items include chemical plants, refineries, and factories. The split frame device 20 may be constructed as a modular, lightweight, portable device to accommodate mounting on the many types of cylindrical items 28. Furthermore, the split frame device 20 may be utilized in advancing and retracting many types of tools in radial and/or axial directions to enable performance of the desired machining tasks or other tasks with respect to the cylindrical item 28. Similarly, the split frame device 20 may incorporate various types of additional components to facilitate a given operation.

Additionally, the split frame device 20 may be used to perform many types of cutting operations. For example, the tool 38 may be a cutting tool mounted to the tool assembly 34 via a suitable tool mount. The cutting tool 38 may be designed for various types of cutting operations including resurfacing operations, oxidation removal operations, grinding operations, deep cutting operations, and/or other cutting operations. However, the tool 38 may be designed and selected for various other operations including cleaning operations, testing operations, monitoring operations, coating operations, or other suitable operations.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for performing an operation on a cylindrical item, comprising:
a split frame device having separable sections to enable mounting of the split frame device about the cylindrical item, the split frame device comprising:
a first non-rotating split frame steady assembly and a second non-rotating split frame steady assembly supported by linear rails;
a rotating tool carrier assembly movably mounted on the linear rails between the first and second non-rotating split frame steady assemblies, the rotating tool carrier assembly comprising a rotatable component while also being movable axially along the linear rails, the rotating tool carrier assembly having separable sections to enable positioning about the cylindrical item such that the rotatable component may be rotated about the cylindrical item; and
at least one power source mounted to impart axial movement to the rotating tool carrier assembly and rotational movement to the rotatable component.

2. The system as recited in claim 1, further comprising a tool mounted to the rotatable component for interaction with the cylindrical item.

3. The system as recited in claim 1, further comprising a cutting tool mounted to the rotatable component for performance of a cutting operation on the cylindrical item.

4. The system as recited in claim 1, wherein each of the first and second non-rotating split frame steady assemblies comprises separable sections which may be separated and recombined via fasteners.

5. The system as recited in claim 4, wherein each of the first and second non-rotating split frame steady assemblies comprises a plurality of adjustable clamp assemblies mounted to the separable sections.

6. The system as recited in claim 1, wherein the at least one power source comprises a motor.

7. The system as recited in claim 6, wherein the motor is operable to move the rotating tool carrier assembly axially along the linear rails via a feed screw.

8. The system as recited in claim 6, wherein the motor is operable to impart rotational movement to the rotatable component via a gear.

9. The system as recited in claim 3, wherein the position of the cutting tool is radially adjustable.

10. A system, comprising:
a split frame device having separable sections to enable mounting of the split frame device about a cylindrical item, the split frame device comprising:
a plurality of non-rotating split frame steady assemblies supported by linear rails;
a rotating tool carrier assembly movably mounted on the linear rails between non-rotating split frame steady assemblies of the plurality of non-rotating split frame steady assemblies, the rotating tool carrier assembly comprising a rotatable component, the rotating tool carrier assembly having separable sections to enable positioning about the cylindrical item such that the rotatable component may be rotated about the cylindrical item; and
a power source mounted to impart rotational movement to the rotatable component.

11. The system as recited in claim 10, wherein the power source also imparts axial movement to the rotating tool carrier assembly.

12. The system as recited in claim 10, wherein the plurality of non-rotating split frame steady assemblies comprises two non-rotating split frame steady assemblies in the form of a first non-rotating split frame steady assembly and a second non-rotating split frame steady assembly.

13. The system as recited in claim 12, further comprising a tool mounted to the rotatable component for interaction with the cylindrical item.

14. The system as recited in claim 12, further comprising a cutting tool mounted to the rotatable component for performance of a cutting operation on the cylindrical item.

15. The system as recited in claim 12, wherein each of the first and second non-rotating split frame steady assemblies comprises separable sections which may be separated and recombined via fasteners.

16. The system as recited in claim 15, wherein each of the first and second non-rotating split frame steady assemblies comprises a plurality of adjustable clamp assemblies mounted to the separable sections.

17. The system as recited in claim 12, wherein the power source comprises a motor.

18. A method, comprising:
providing a split frame device with a rotating tool carrier assembly having a tool assembly configured to receive a tool;
separating sections of the split frame device to enable positioning of the split frame device around a cylindrical item;
positioning and closing the split frame device about the cylindrical item;
operating the rotating tool carrier assembly to rotate the tool assembly about the cylindrical item; and
subsequently releasing the split frame device from the cylindrical item.

19. The method as recited in claim 18, further comprising mounting the tool to the tool assembly such that operating comprises performing a cutting operation on the cylindrical item as the tool assembly is rotated about the cylindrical item.

20. The method as recited in claim 19, wherein operating further comprises moving the tool carrier assembly in an axial direction while performing the cutting operation.
